(19) United States
(12) Patent Application Publication
(10) Pub. No.: US 2025/0164185 A1
(43) Pub. Date: May 22, 2025

(54) METHOD FOR DRYING PANELS AND DRYER

(71) Applicant: GRENZEBACH BSH GMBH, Bad Hersfeld (DE)

(72) Inventor: Christoph STRAETMANS, Schenklengsfeld (DE)

(73) Assignee: GRENZEBACH BSH GMBH, Bad Hersfeld (DE)

(21) Appl. No.: 18/840,220

(22) PCT Filed: Feb. 17, 2023
(86) PCT No.: PCT/EP2023/025075

§ 371 Date: Aug. 21, 2024

(30) Foreign Application Priority Data
Feb. 21, 2022 (DE) 10 2022 000 627.8

(51) Int. Cl. F26B 3/04; F26B 15/12; F26B 23/00; F26B 25/00

(52) U.S. Cl. CPC F26B 3/04; F26B 15/12; F26B 23/002; F26B 25/004

(57) ABSTRACT

A method for drying panels in a drying device includes first and second stages. Each stage has levels, and each panel is placed on surfaces formed at different levels and guided through the drying device in each level. In the first stage, the panels are brought into contact with drying air with a high temperature and are dried, and in the second stage, the panels are dried using drying air with a lower temperature. The support surface in the levels of the first stage for placing the panels is smaller than the support surface in the second stage, and the panels are guided in the second stage at a second speed which is lower than the first speed in the first stage, wherein the product of the first support surface and the first speed is equal to the product of the second support surface and the second speed.

When drying panels, in particular building panels containing cement and gypsum, the panels conveyed through a dryer are brought into contact with heated air.

The drying air can be supplied in the form of longitudinal aeration, transverse aeration or transverse aeration using nozzle boxes equipped with nozzles. With longitudinal ventilation, the drying air is supplied at one end of the dryer or, if it is divided into several zones, at one end of a zone and discharged at the opposite end.

With cross ventilation, it is fed in at several points on the sides of the dryer and discharged at the opposite sides, enabling more intensive drying in the dryer. Particularly intensive drying is achieved with cross ventilation via nozzles through the jet dryer in impingement flow.

In most cases, a recirculation process is used, in which a large proportion of the drying air is circulated. In this case, most of the drying air is reheated after contact with the material to be dried and thus reused. Only a small proportion of the drying air is discharged to the outside as exhaust air and a proportion corresponding to the exhaust air is fed in from the outside as supply air.

Fuel, i.e. primary energy, is required to heat the drying air, for example using burners or heating registers, and electrical energy, i.e. secondary energy, is required to supply the air using fans. The use of primary energy as well as secondary energy must be reduced in order to enable a more energy-efficient production of the above-mentioned panels.

DE 26 13 512 A1 discloses a drying method in which low primary energy consumption is achieved by using condensation heat from the exhaust air. This process has a two-stage design. In the first dryer stage, drying takes place at high temperature and high humidity and in the second dryer stage at low temperature and low humidity, whereby the drying capacity of the first stage is twice to three times as high as that of the second stage and the second dryer stage is heated from the exhaust air of the first dryer stage with the interposition of a heat exchanger. In both stages, the drying air is supplied in a recirculation process, namely in the first dryer stage in the form of longitudinal ventilation and in the second dryer stage in the form of cross ventilation with a large mass flow of recirculated air. However, the second stage requires a large mass flow of circulating air and therefore a high consumption of secondary energy.

When reducing the consumption of primary energy by also using the condensation heat of the exhaust air, the general problem arises that the waste heat of the exhaust air is only available at a low temperature level. Although a lower temperature of the drying air can be compensated for by larger air mass flows, this leads to a greater consumption of secondary energy.

WO 95/04908 A1 discloses a method for drying boards conveyed in tiers through a dryer, in which the boards are brought into contact with drying air in two stages A and B, wherein drying is carried out in stage A in a circulating air process with drying air of high temperature and at least medium humidity and with a drying capacity two to four times higher than in stage B. In stage B, the exhaust air from stage A is passed through a heat exchanger arranged in the shelves of the dryer; at the same time, the drying air at low temperature and low humidity is passed in counterflow to the exhaust air from stage A.

It is the object of the present invention to further improve the method according to the preamble of claim 1.

According to the invention, this object is resolved as disclosed by claim 1.

By the method according to the invention, the transport speed of the panels to be dried is adapted to the respective energy absorption and the associated dehumidification of the panels, so that they are dried with a minimum energy input.

The selection of the speed determined for each stage according to the desired drying progress also results in a higher transport speed in stage A than in stage B for drying in stage A at a higher temperature than in stage B. This means that the speed of the panels leaving stage A is lowered to the speed level of stage B in a separate conveyor located between stage A and stage B. At the same time, in order to avoid intermediate storage of panels in the area of the conveyor, the conveyor distributes the panels over a larger area in stage B in accordance with the speed difference between stages A and B. This is done by distributing the panels over a larger number of levels or tracks in the area of level B compared to level A. A conveyor device, for example a discontinuous conveyor, is used here, which on the one hand picks up panels at a higher speed on the side facing stage A and discharges them on the side facing stage B onto a higher number of levels or tracks of stage B, whereby the conveyor on this side preferably has a lower speed. The conveyor has a tilting point at the transition to stage B in order to distribute the panels to the levels of stage B. In the case of a higher number of lanes, several panels are preferably transported next to each other on one level, for example in two to four lanes.

On the one hand, this measure creates a compact entrance area of the dryer with stage A that can be passed through at high speed and high temperature, which is also suitable for ensuring the final activation of solidifying agents contained in the panels, such as starch.

On the other hand, the area and speed within stage B are designed to achieve sufficient drying of the panels while at the same time making the best possible use of the energy from stage A.

In order to achieve the best possible coordination between stages A and B, the invention provides that the product of the contact area of the panels, i.e. the area actually occupied by the panels in stage A, with the speed of the panels in stage A is equal to the product of the speed of the panels in stage B with the contact area occupied by the panels in stage B. As a result, this leads to a larger contact surface of the panels in stage B, combined with a longer dwell time of the panels in stage B. In stage B, the panels are dried at a lower temperature. The energy input in stage B for heating the panels is greatly reduced compared to the energy input required for heating in stage A, because heat from heat recovery is used for drying in stage B.

In order to achieve rapid drying in stage A, the panels are preferably heated there by an impingement flow of hot air. The impingement flow is preferably generated by nozzle boxes, which are equipped with a large number of nozzles from which an air flow is applied to the panels at right angles to the direction in which they are transported.

On the one hand, the nozzle boxes enable a good drying result for the panels in a short period of time, but require a high energy input to generate the required air flow. On the other hand, the nozzle boxes also take up a considerable amount of space within stage A, whereby this stage A usually has a number of sections, and the nozzle boxes are arranged one above the other in each of the sections according to the number of levels of stage A.

According to the invention, it is also possible to design stage A with longitudinal ventilation and to use nozzle boxes.

Since, according to the invention, no nozzle boxes are required in stage B, because a crossflow of air, if required, is generated by corresponding fans, the distance between the levels on which the panels to be dried rest can be smaller than in stage A. The transport rollers are arranged closer together to form transport paths.

In stage B, for example, a drying device is thus provided with a conveyor system with a plurality of bays or sections extending one behind the other in the conveying direction for conveying continuous panels to be dried in a plurality of levels per bay with conveying devices arranged in the levels in the form of roller conveyors. A drive system drives a plurality of endless chains, each of which is assigned at least one drive. Preferably, the roller conveyors in all levels of a bay can be driven by at least one single chain in each case.

The roller conveyors are used to guide the panels one above the other in a very compact manner. Since stage B requires a greater length than stage A due to the longer drying time of the panels to be dried, a greater number of panels per height of stage B and/or per width of stage B is made possible on the other side, so that overall a very high utilization of space is created in stage B, while at the same time the exhaust air from stage A is optimally utilized in order to introduce its residual heat into the panels by means of at least one heat exchanger.

For this purpose, a drive system is used which is adapted to a dryer operating at low temperature and to the high number of panels, in particular plasterboards, which are processed simultaneously in the low-temperature dryer over a high number of levels, for example 16 to sixty levels. By using a high number of levels in conjunction with the drive system according to the invention, a longer dwell time of the panels, in particular the plasterboards, can be realized in a low-temperature dryer with the same dryer length as in a high-temperature dryer.

Due to this concept of connecting a stage A, which is preferably at least partially equipped with nozzle boxes, existing dryer systems with several sections, each equipped with nozzle boxes, can also be converted into a dryer according to the invention by continuing to use at least some of these sections, whereby they form stage A, and attaching an additional stage B to stage A, whereby continuous operation between stages A and B is maintained by increasing the number of levels in stage B with a corresponding reduction in the transport speed, while at the same time the thermal energy still available from stage A is utilized in stage B. In the low-temperature dryer formed by stage B, the idlers of the transport system used there are supported by roller bearings. The graphite-based plain bearings required for high-temperature dryers are not needed; the fact that roller bearings have lower coefficients of friction than plain bearings can be utilized here, whereby, for example, idlers with internal roller bearings are used. This saves a considerable amount of energy in the stage B low-temperature dryer because the roller bearings used in stage B generate much less friction than the plain bearings in stage A.

It can therefore be seen that particularly large energy savings are possible when the dryer arrangements according to the invention are installed in an existing system.

To turn an existing system into a dryer according to the invention, a conveyor system and a low-temperature stage (stage B) must be added. In other cases, some sections of stage A of an existing dryer are removed, and a conveyor and a low-temperature stage B are added.

Advantageous embodiments of this method are shown in the dependent claims and the description, in particular in conjunction with the drawings.

Preferably, the panels are transferred between the first stage A and the second stage B via a transfer or transfer device, in particular via a continuous conveyor or a discontinuous conveyor; in this case, the panels are slowed down from the speed at which they move in stage A until they reach the second, lower speed in stage B.

During the transition between stages A and B, the panels are raised or lowered to different levels in the transfer or transfer device or the continuous conveyor or the discontinuous conveyor and transferred to the levels of the second stage B. It is understood that the transfer device is preferably also enclosed like stages A and B. In order to achieve rapid drying in stage A, the panels are dried there at least essentially by the use of nozzle boxes.

For optimized utilization of the waste heat generated in particular in stage A, the panels are dried by at least one internal heat exchanger in the first stage A and/or in the second stage B and/or by at least one external heat exchanger.

It is also advantageous if the panels are heated in the first stage A by means of circulating air through a burner directly or by means of superheated steam or thermal oil or electrically indirectly or by means of low-calorific heat. In stage B, panels are heated by low-calorific heat, either from heat recovery from stage A or from another process in which heat is released at low temperatures, for example from a combined heat and power plant or a heat pump.

Preferably, the panels are dried in the first stage A by drying air at a temperature of 130 to 300° C., while the panels are dried in the second stage B by drying air at a temperature of 20 to 90° C.

Advantageously, the exhaust air from the drying process of the first stage A can be reused by passing it into a heat exchanger to preheat the drying air of the second stage B.

An even higher efficiency of the drying process according to the invention can be achieved if the panels are first dried in a pre-drying stage upstream of the first stage A, then in the first stage A and finally in the second stage B.

Preferably, the panels are conveyed through sections in stages A, B by means of separate conveying devices for each stage A, B and/or each section. Alternatively, the conveying devices are each driven by direct drive motors, or they are at least partially interconnected by the use of gears.

The invention also provides a dryer for drying panels in a first and a second stage A, B, each equipped with a conveyor device for conveying the panels arranged in levels through the dryer, wherein the first stage (A) comprises at least one zone, wherein the first stage A comprises a feed device, a discharge device and a recirculation device, a discharge device and a circulating air duct with conveying means and a heating device for circulating air, as well as means for supplying supply air and means for discharging exhaust air, and wherein the second stage B is equipped for taking over the panels from the first stage A and with a supply device for drying air and a discharge device for drying air and a heating device.

It is the object of the invention to design the dryer in such a way that the panels are dried with a low energy input.

According to the invention, this object is resolved in that a transfer device, a continuous conveyor or a discontinuous conveyor is arranged between the first and the second stage A, B, by means of which the panels can be slowed down from the conveying speed in the first stage A to the conveying speed of the second stage B and can be raised or lowered to the height of the levels of the conveying device of the second stage B or can be distributed on tracks running side by side within the levels of the second stage B.

The panels are dried in each of the two stages at a speed and temperature that ensures a fast throughput of the panels through the dryer while at the same time making efficient use of energy.

This optimizes the use of both primary and secondary energy. In particular, the primary energy used is maintained by utilizing the waste heat and also the condensation heat of the exhaust air, without increasing the demand for secondary energy by circulating large air mass flows.

In particular, high conveying capacities for circulating the air are avoided in the second stage, so that this dryer has only a low consumption of secondary energy.

Advantageous further embodiments are shown in the dependent claims.

A dryer in which the first and second stages A, B each comprise at least one section and which are equipped with means for flowing the circulating air transversely to the conveying direction of the panels is advantageous.

For design reasons, the first stage A of the dryer is preferably divided into several sections, at least some of which are equipped with nozzle boxes for transverse ventilation by means of impingement flow of hot air.

It is advantageously provided that the second stage B of the dryer is equipped with means for flowing the circulating air against and/or in the conveying direction of the panels.

In a further advantageous embodiment of the dryer, it is provided that the second stage B is equipped with guide means for helically guiding the circulating air or with at least one exhaust air fan in conjunction with at least one circulating air fan. Alternatively, guide means, for example in the form of guide panels, are provided.

Preferably, the dryer comprises at least one heat exchanger.

Roller conveyors or conveyor belts are preferably provided as conveying devices for transporting the panels to be dried in the dryer.

In stage B, the exhaust air from stage A, which has a high water vapor content and is passed through the heat exchanger, is cooled by the low-temperature drying air to such an extent that some of the water vapor condenses.

The primary energy is used intensively by also utilizing the condensation heat, which is made possible by the low temperature of the drying air cooling the heat exchanger and the at least medium humidity of the exhaust air from stage A.

When the drying air is routed in counterflow to the exhaust air from stage A, which is routed through the heat exchanger, cooler drying air meets exhaust air that has already cooled down. This ensures the greatest possible condensation of the water vapor contained in the exhaust air and further improves the use of primary energy.

The more intensive use of primary energy leads to considerable savings in primary energy.

Overall, stage B dries at no more than half the drying capacity of stage A.

Each stage A, B is equipped with a conveyor device for conveying sheets arranged in levels through the dryer. The dryer can be designed as a roller conveyor dryer or belt dryer, whereby the conveyor device has several roller conveyors or conveyor belts arranged one above the other.

The conveyor device arranged between stage A and the stage is preferably enclosed, so that the thermal energy from stage A is not lost when the panels pass into stage B.

The panel dryer according to the invention can be set up in a compact manner; it is not necessary to provide a base panel for the dryer, rather it is sufficient if the side walls of the dryer are set up directly on the floor of a factory hall without having to lay an additional base panel for the dryer.

For additional transient loads, additional heating devices can be installed in stage B.

The invention is explained in more detail below using examples of embodiments. These are shown by:

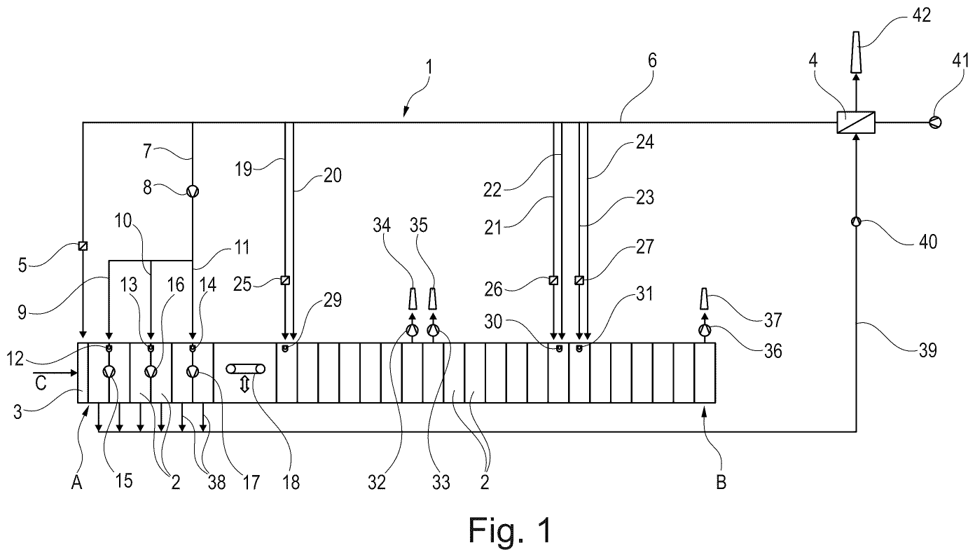

FIG. 1 a dryer with two stages A and B and a conveyor installed between stages A and B, in a first embodiment,

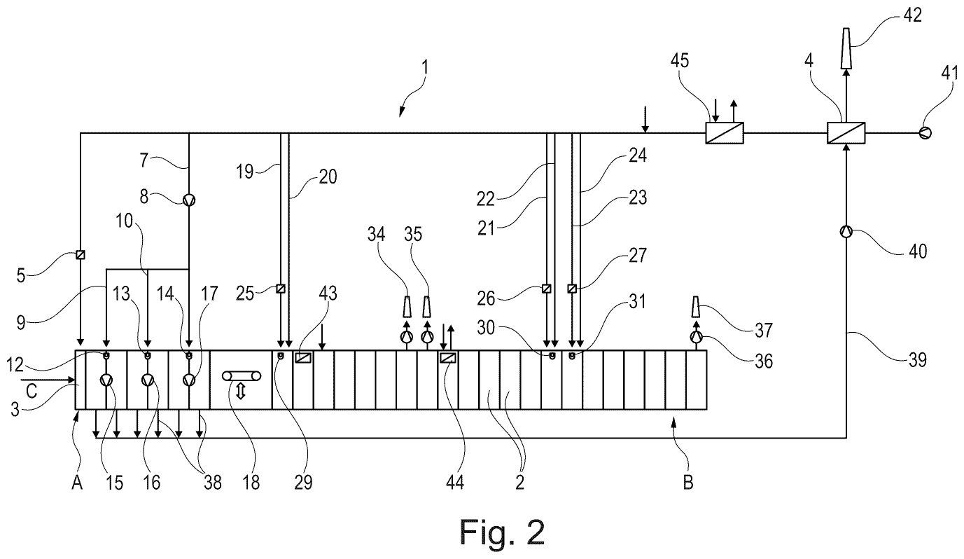

FIG. 2 the dryer with the two stages A and B and the conveyor in a second embodiment,

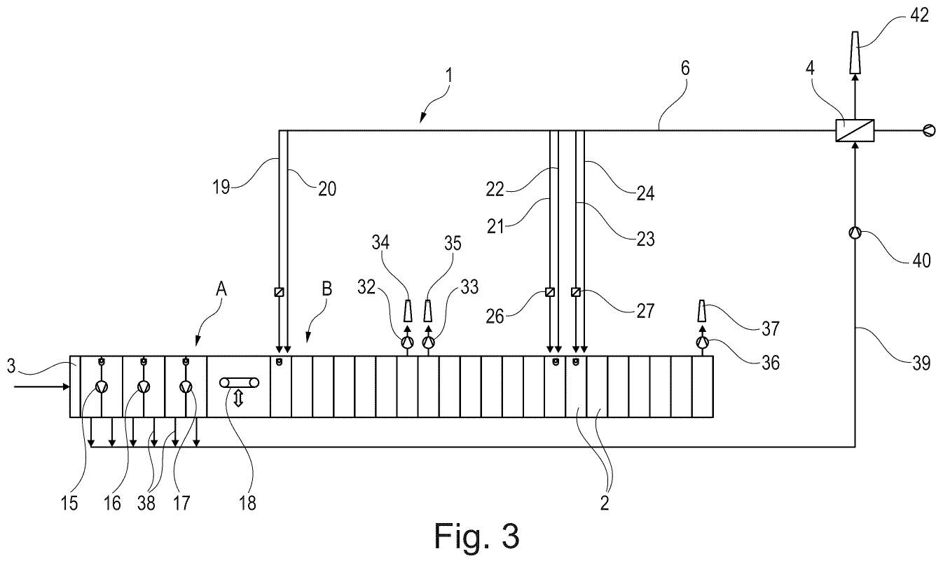

FIG. 3 the dryer with the two stages A and B and the conveyor in a third embodiment,

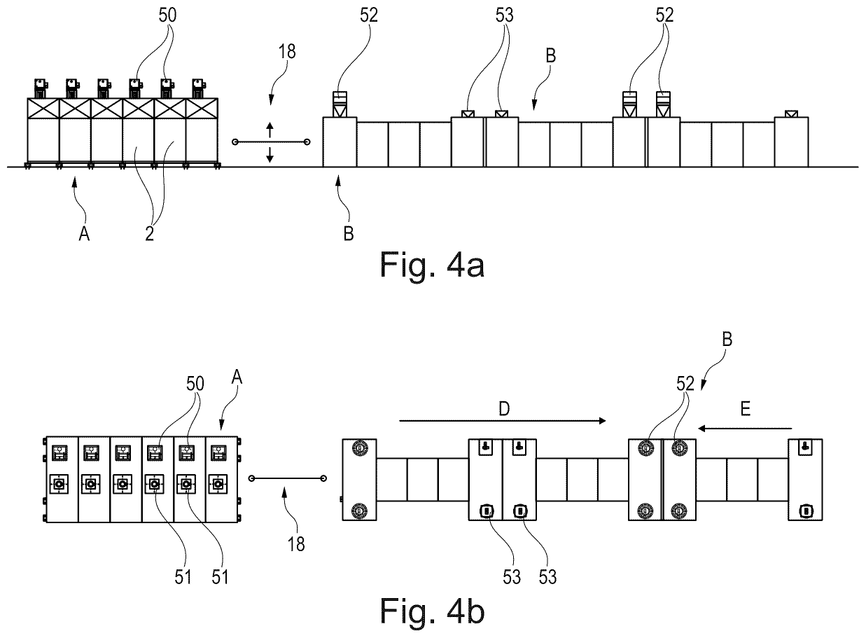

FIG. 4a a dryer in a side view and

FIG. 4b a top view of the dryer according to FIG. 4a.

A dryer 1 (FIG. 1) comprises two stages A and B for drying panels, which are fed to the dryer 1 in the direction of an arrow C. These panels are in particular building material panels, for example plasterboards or gypsum wallboards.

Each of the two stages A and B is preferably divided into sections 2. This applies in particular to section A, which is preferably designed as a nozzle dryer. This means that at least in the greater number of sections of stage A, nozzle boxes are arranged from which hot air is blown onto the panels in an impingement flow. This generates a temperature of 130 to 300° C. within the sections 2 of stage A.

Preferably, stage A has a pre-drying section 3 on the inlet side. The pre-drying stage 3 is supplied by a heat exchanger 4 with fresh air heated in it via a supply line 6 equipped with a closable flap 5; in addition to heating the panels, this fresh air supply also serves to seal stage A against other air flows and the ingress of outside air into stage A.

Via a pipe 7 branching off from the supply pipe 6, heated fresh air is distributed to individual pipes 9, 10, 11 by means of a fan 8. From each of these, the fresh air reaches heating devices 12, 13 or 14, which are arranged, for example, in a ceiling box above the nozzle boxes. As shown in FIG. 1, the heating devices 12 to 14 are each assigned to two sections 2 of stage A. It is understood that in another embodiment, other assignments can also be made. For example, in another embodiment, one heating device is provided for each section. The heating devices 12 to 14 are preferably direct heating devices such as burners or indirect heating devices such as steam or electric heaters. Within the sections 2 or jointly for each section, at least one recirculation fan 15 to 17 is provided to generate a cross-flow of the heated air in the sections 2 as recirculated air. Alternatively, two recirculation fans 15 to 17 are arranged for each section 2.

The pre-dried panels are transported from stage A to stage B via a conveyor 18. Since stage B has a higher number of levels than stage A, the conveyor 18 feeds the panels into the levels of stage B at smaller distances from each other, but at a correspondingly reduced speed. This allocation is realized, for example, by the conveyor 18 as a transfer device having a larger radius of curvature of its conveyor belt on the side facing stage A, which also results in a greater relative speed of the conveyor belt on this side.

On the side facing stage B, the conveyor belt then has a lower circulation speed resulting from a smaller radius of curvature, whereby a relatively higher number of panels is to be distributed over the larger number of stages of stage B. Like stages A and B, conveyor 18 is preferably insulated against heat loss to the outside. Heating devices and fans for air circulation or air exchange can also be arranged in it.

For example, stage A has six to sixteen levels, while stage B has eighteen to forty-eight levels, with stage B being operated at a conveying speed of the panels which is, for example, only two-thirds of the conveying speed in stage A. Instead of a higher number of levels, the levels in stage B are wider than in stage A, so that instead of a single lane of panels in stage A, two lanes of panels are transported within one level of stage B. In another embodiment, two lanes are transported side by side on one level in level A, while three lanes are transported on one level in level B.

Stage B is also supplied with heated fresh air from the heat exchanger 4. Ducts 19 to 24 are used for this purpose, of which ducts 19, 21 and 23 are each provided with a sealing flap 25, 26 and 27 respectively.

Fans can also be arranged in ducts 19 to 24. At the entrance to sections 2, the air flowing into sections 2 from ducts 19 to 24 is heated by heating devices 29 to 31. The heating devices 29 to 31 are switched on when additional heating energy is required; this is the case when the system is started up if there is not yet sufficient heat available from stage A and the heat exchanger 4 is not yet receiving warm exhaust air or not enough warm exhaust air from stage A. The heating devices are also required when the system is shut down and insufficient warm air is provided from stage A to enter stage B. The heating devices 29 to 31 can also be used in the event that the panels to be dried have a higher moisture content than expected, as well as when changing between different panel formats, which can lead to a lack of thermal energy in stage B. The heating devices 29 to 31 are therefore provided in particular for transient loads in stage B.

It will be understood that a plurality of conduits for supplying air, in particular warm air from the heat exchanger 4 or from another heat exchanger, may be provided in accordance with the length of the stage B in order to recover the enthalpy of vaporization of the water evaporated from the panels.

Optionally, recirculation fans are also provided in stage B, which are constructed and arranged in the same way as the recirculation fans in stage A. Both radial and axial fans are possible.

Just like the recirculation fans, exhaust air fans 32, 33 are also distributed over the entire length of stage B, of which only the exhaust air fans 32, 33 are shown as examples in FIG. 1. Moist air is removed from stage B via these fans and chimneys 34, 35.

In addition, there is also an exhaust fan 36 at the end in conjunction with a chimney 37.

An internal heat exchanger can be provided both in stage A and in stage B, for example above the nozzle boxes in stage A in a ceiling box or above the conveying device in stage B, also in a ceiling box to be provided for this purpose.

The heat exchanger 4 is connected to the sections 2 of stage A via exhaust air ducts 38 and a central exhaust air duct 39. Warm, moisture-saturated air is fed to the heat exchanger 4 via the exhaust air ducts 38, 39 and an exhaust air fan 40, where it condenses and releases its moisture as water.

The heat exchanger 4 draws in fresh air via a fresh air fan 41. It releases used air into the environment via a chimney 42.

In another design example (FIG. 2), there are several internal heat exchangers 43, 44 in various sections of stage B, which are supplied either directly or indirectly with hot air, for example with flue gases from a combined heat and power plant or from gas turbines or other hot gas flows from other processes. Such gases can also be fed additionally to the heat exchanger 4. Or they are fed to a further heat exchanger 45, which is connected in series with the heat exchanger 4 and serves to further heat the gases, which are fed to stages A, B via lines 6, 7, 19, 20, 21, 22, 23, 24.

In a further embodiment (FIG. 3), the heat exchanger 4 is only connected to stage B with regard to the air supply; such an arrangement exists, for example, if stage B is subsequently connected to an existing dryer, i.e. to an already existing stage A.

In one embodiment (FIG. 4a, b), a dryer 1 as shown in FIGS. 1 to 3 has a plurality of burners 50 in stage A, each of which is mounted in the ceiling area or on the ceilings of sections 2 of stage A to heat the air in sections 2. Circulation fans 51 circulate the air heated by the burners 50 in a circular motion perpendicular to the conveying direction of the panels in stage A.

Stage B is equipped with hot air inlets 52, which are also fitted to the top of individual sections 2. The hot air inlets 52 are mounted in pairs on the tops of the sections 2, for example, as can be seen in FIG. 4b.

In stage B, exhaust fans 53 are also arranged in some sections 2. The exhaust fans 53 are preferably mounted laterally on the ceilings of the sections 2, wherein preferably inlets for warm air, which is supplied either by the heat exchanger 4 and/or by the heat exchanger 45, are provided opposite the exhaust fans 53 on the other side of the ceilings of the sections 2.

Preferably, the fans 53 are arranged in stage B in such a way that air flows are created in the longitudinal direction of stage B. Preferably, an air flow in the conveying direction (arrow D) of the panels is generated in the front part of stage B facing the transfer device, while an air flow against the conveying direction of the panels (arrow E) is generated in the rear part.

1. Method for drying panels in a drying device comprising a first stage and a second stage, wherein the two stages each have levels and the panels are each placed on surfaces formed in levels and are passed through the drying device in the respective levels of the two stages, wherein the panels are brought into contact with drying air of high temperature in the first stage and dried and are dried with drying air of a less high temperature in the second stage, wherein the support surface available in the levels of the first stage for placing the panels is smaller than the support surface in the second stage, in that the panels are passed through the second stage at a second speed which is lower than the first speed in the first stage, the product of the first support surface with the first speed being equal to the product of the second support surface with the second speed.

2. Method according to claim 1, wherein the panels in the second stage are guided in a higher number of levels which run above each other or next to each other.

3. Method according to claim 1, wherein the panels are transferred between the first stage and the second stage via a transfer device, a continuous conveyor or a discontinuous conveyor, whereby the panels are slowed down until they reach the second speed.

4. Method according to claim 1, wherein the panels are raised or lowered to different levels in the transfer device or the continuous conveyor or the discontinuous conveyor and transferred to the levels of the second stage.

5. Method according to, claim 1, wherein the panels in the region of the first stage are dried at least substantially by the use of nozzle boxes.

6. Method according to, claim 1, wherein the panels are dried by an internal heat exchanger and/or by at least one external heat exchanger in the first stage or in the second stage.

7. Method according to, claim 1, wherein the panels are heated in the first stage by means of circulating air through a burner directly or by means of superheated steam or thermal oil or electrically indirectly or by means of low-calorific heat.

8. Method according to claim 1, wherein the panels are dried in the first stage by drying air at a temperature of 130 to 300° C.

9. Method according to claim 1, wherein the panels are dried in the second stage by drying air at a temperature of 20 to 90° C.

10. Method according to claim 1, wherein the exhaust air of the first stage is fed into a heat exchanger for preheating the drying air of the second stage.

11. Method according to claim 1, wherein the panels are first dried in a pre-drying stage upstream of the first stage then in the first stage and finally in the second stage.

12. Method according claim 1, wherein the panels are conveyed in the stages in each case through sections by means of separate conveying devices for each stage.

13. Dryer for drying panels in a first and a second stage, each equipped with a conveying device for conveying the panels arranged in levels through the dryer, the first stage having at least one zone, the first stage having a feed device, a discharge device and a recirculation device, a discharge device and a circulating air duct with conveying means and a heating device for circulating air, as well as means for supplying supply air and means for discharging exhaust air, and wherein the second stage is equipped for taking over the panels from the first stage and with a supply device for drying air and a discharge device for drying air and a heating device, wherein a transfer device, a continuous conveyor or a discontinuous conveyor is arranged between the first and the second stage, by means of which the panels can be slowed down from the conveying speed in the first stage to the conveying speed of the second stage and can be raised or lowered to the height of the levels of the conveying device of the second stage or can be distributed to tracks of the conveying device of the second stage running side by side.

14. Dryer according to claim 13, wherein the first and the second stage each comprise at least one section and are equipped with means for flowing the circulating air transversely to the conveying direction of the panels.

15. Dryer according to claim 13, wherein the first stage of the dryer has several sections which are at least partially equipped with nozzle boxes for transverse ventilation by means of impingement flow of hot air.

16. Dryer according to claim 13, wherein the second stage is equipped with means for flowing the circulating air against and/or in the conveying direction of the panels.

17. Dryer according to claim 16, wherein the second stage is equipped with guide means for helically guiding the circulating air or with at least one exhaust air fan in conjunction with at least one circulating air fan.

18. Dryer according to claim 13, wherein it comprises at least one heat exchanger.

19. Dryer according to claim 13, wherein the conveying devices comprise roller conveyors or conveyor belts.

20. Dryer according to claim 13, wherein the panels in the stages can be transported in a plurality of tracks running side by side within the levels.
